(19) United States
(12) Patent Application Publication
(10) Pub. No.: US 2013/0148021 A1
(43) Pub. Date: Jun. 13, 2013

(54) BROADCAST RECEIVER FOR DISPLAYING EXPLANATION OF TERMINOLOGY INCLUDED IN DIGITAL CAPTION AND METHOD FOR PROCESSING DIGITAL CAPTION USING THE SAME

(71) Applicant: SAMSUNG ELECTRONICS CO., LTD., Gyeonggi-do (KR)

(72) Inventors: Yeo-ri YOON, Suwon-si (KR); Yong-hwan KWON, Seongnam-si (KR); Sang-hee LEE, Seoul (KR); Jeong-yeon LEE, Seongnam-si (KR); Mi-ju PARK, Seoul (KR); Won-il KIM, Gwacheon-si (KR); Woo-seok HWANG, Seoul (KR)

(73) Assignee: SAMSUNG ELECTRONICS CO., LTD., Gyeonggi-do (KR)

(21) Appl. No.: 13/758,757

(22) Filed: Feb. 4, 2013

Related U.S. Application Data
(63) Continuation of application No. 12/468,457, filed on May 19, 2009.

(30) Foreign Application Priority Data
Sep. 10, 2008 (KR) 2008-0089305

(51) Int. Cl. H04N 7/088

(52) U.S. Cl. CPC H04N 7/088
USPC 348/468

(57) ABSTRACT

A broadcast receiver and a method for processing a digital caption using the same. A broadcast receiver receives a broadcast signal containing digital caption information, searches for an explanation of terminology to be explained if terminology in the digital caption information is included in a list of terminology to be explained, and displays the explanation found for the terminology to be explained on a screen.

### CROSS-REFERENCE TO RELATED APPLICATIONS

This application is a continuation of U.S. application Ser. No. 12/468,457 filed May 19, 2009, which claims priority from Korean Patent Application No. 10-2008-0089305, filed Sep. 10, 2008 in the Korean Intellectual Property Office, the disclosures of which are incorporated herein by reference in their entirety.

### BACKGROUND OF THE INVENTION

1. Field of the Invention

Apparatuses and methods consistent with the present invention relate to a broadcast receiver and a method for processing a digital caption using the same, and more particularly, to a broadcast receiver for displaying an explanation of terminology in a digital caption, and a method for processing a digital caption using the same.

2. Description of the Related Art

People have access to a diverse range of information via television (TV). For example, people may hear about diverse technical fields on the news and view sports on the TV.

While watching the TV, users may not understand technical terminology used by news anchors or sports commentators. In this case, users may ignore the unknown terms or look up the terms on the dictionary.

If coined words or technical terms appear while a user is watching the TV, the user must inconveniently look up the words in a dictionary so as to understand the words.

Therefore, there is a need for methods for users to know the meaning of technical terms on the TV with greater ease and convenience.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides a broadcast receiver which searches for an explanation of terminology and displays the explanation of the terminology on a screen if the terminology in the digital caption information is included in a list of terminology to be explained, and a method for processing a digital caption using the same, so that users can easily understand the meaning of the terminology used in a broadcast program.

According to an exemplary aspect of the present invention, there is provided a broadcast receiver, including a broadcast reception unit which receives a broadcast signal containing digital caption information, a storage unit which stores a list of terminology to be explained, a control unit which searches for explanation of terminology to be explained if terminology in the digital caption information is included in the list of terminology to be explained, and a display unit which displays the explanation found for the terminology to be explained on a screen.

The broadcast reception unit may receive electronic program guide (EPG) information together with the digital caption information, and the control unit may extract information on a title or genre of a currently viewed broadcast program from the EPG information, and search for an explanation of the terminology to be explained corresponding to the extracted information on the title or the genre of the currently viewed broadcast program.

The broadcast reception unit may receive EPG information together with the digital caption information, the storage unit may store a plurality of lists of terminology to be explained, which are categorized according to a title or genre of a broadcast program, and the control unit may extract information on the title or genre of a currently viewed broadcast program from the EPG information, select a list of terminology to be explained corresponding to the extracted information on the title or the genre of the currently viewed broadcast program, from among the plurality of lists of terminology to be explained, and search for an explanation of the terminology to be explained if the terminology in the digital caption information is included in the selected list of terminology to be explained.

The storage unit may store at least one explanation for each of a large amount of terminology, and the control unit may search for explanation of the terminology to be explained from the explanations stored in the storage unit if the terminology in the digital caption information is included in the list of terminology to be explained.

The broadcast receiver may further include a network interface which is communicably connected to the Internet. The control unit may search for an explanation of the terminology to be explained over the Internet through the network interface if the terminology in the digital caption information is included in the list of terminology to be explained.

The display unit may display the explanation found for the terminology to be explained on the screen even when the digital caption information is not displayed on the screen.

The broadcast receiver may further include an input unit which receives a user's manipulation. The display unit may display the terminology to be explained on the screen if the terminology in the digital caption information is included in the list of terminology to be explained, and display an explanation of the terminology to be explained on the screen if predetermined manipulation is input through the input unit when the terminology is displayed on the screen.

The broadcast receiver may further include an input unit which receives a user's manipulation. The display unit may display the digital caption information on the screen by displaying the terminology to be explained in the digital caption information differently from the remaining terminology on the screen if the terminology in the digital caption information is included in the list of terminology to be explained, and display an explanation of the terminology to be explained on the screen if predetermined manipulation is input through the input unit when the terminology is displayed on the screen.

The broadcast receiver may further include an input unit which receives a user's manipulation. The display unit may display a list of dictionaries for terminology on the screen if the terminology in the digital caption information is included in the list of terminology to be explained, and the control unit may search for explanation of the terminology to be explained from a dictionary selected through the input unit, from among the list of dictionaries for terminology.

The terminology may include at least one of words, phrases, clauses, and sentences.

According to another exemplary aspect of the present invention, there is provided a method for processing a digital caption for a broadcast receiver, the method including storing a list of terminology to be explained, receiving a broadcast signal containing digital caption information, searching for an explanation of terminology to be explained if the terminology in the digital caption information is included in a list of terminology to be explained, and displaying the explanation found for the terminology to be explained on a screen.

The method may further include receiving electronic program guide (EPG) information, and extracting information on a title or genre of a currently viewed broadcast program from the EPG information. In the searching operation, explanation of the terminology to be explained corresponding to the extracted information on the title or the genre of the currently viewed broadcast program may be searched for.

The method may further include receiving electronic program guide (EPG) information, extracting information on a title or genre of a currently viewed broadcast program from the EPG information, and selecting a list of terminology to be explained corresponding to the extracted information on the title or the genre of the currently viewed broadcast program, from among the plurality of lists of terminology to be explained. In the storing operation, a plurality of lists of terminology to be explained may be categorized and stored according to the title or genre of a broadcast program, and in the searching operation, if the terminology in the digital caption information is included in the selected list of terminology to be explained, explanation of the terminology to be explained may be searched for.

The method may further include storing at least one explanation for each of a large amount of terminology. In the searching operation, if the terminology in the digital caption information is included in the list of terminology to be explained, explanation of the terminology to be explained may be searched for from the stored explanations.

The method may further include being communicably connected to the Internet through a network interface. In the searching operation, if the terminology in the digital caption information is included in the list of terminology to be explained, an explanation of the terminology to be explained may be searched for over the Internet through the network interface.

In the displaying operation, the explanation found for the terminology to be explained may be displayed on the screen even when the digital caption information is not displayed on the screen.

The displaying operation may include displaying the terminology to be explained on the screen if the terminology in the digital caption information is included in the list of terminology to be explained, and displaying an explanation of the terminology to be explained on the screen if predetermined manipulation is input through an input unit when the terminology to be explained is displayed on the screen.

The displaying operation may include displaying the digital caption information on the screen by displaying the terminology to be explained in the digital caption information differently from the remaining terminology on the screen if the terminology in the digital caption information is included in the list of terminology to be explained, and displaying an explanation of the terminology to be explained on the screen if predetermined manipulation is input through an input unit when the terminology to be explained is displayed on the screen.

The method may further include displaying a list of dictionaries for terminology on the screen if the terminology in the digital caption information is included in the list of terminology to be explained. In the searching operation, explanation of the terminology to be explained may be searched for from a dictionary selected through the input unit, from among the list of dictionaries for terminology.

The terminology may include at least one of words, phrases, clauses, and sentences.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a schematic block diagram of a television according to an exemplary embodiment of the present invention;

FIGS. 2A and 2B are a flowchart of a method for processing a digital caption according to an exemplary embodiment of the present invention;

FIG. 3A illustrates terminology to be explained in a digital caption using bold type according to an embodiment of the present invention;

FIG. 3B illustrates terminology to be explained in a digital caption in a boxed form according to another embodiment of the present invention;

FIG. 4 illustrates a screen displaying an explanation of terminology to be explained according to an embodiment of the present invention;

FIG. 5 illustrates a screen displaying terminology to be explained when a digital caption is not displayed according to an embodiment of the present invention; and

FIG. 6 illustrates a screen displaying terminology to be explained when a digital caption is not displayed according to another embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

A broadcast receiver is a device to tune to a broadcast signal received from a broadcasting station, and demodulate and display the broadcast signal. Examples of the broadcast receiver include televisions (TVs) and set-top boxes. Hereinbelow, a television is described as an example of a broadcast receiver.

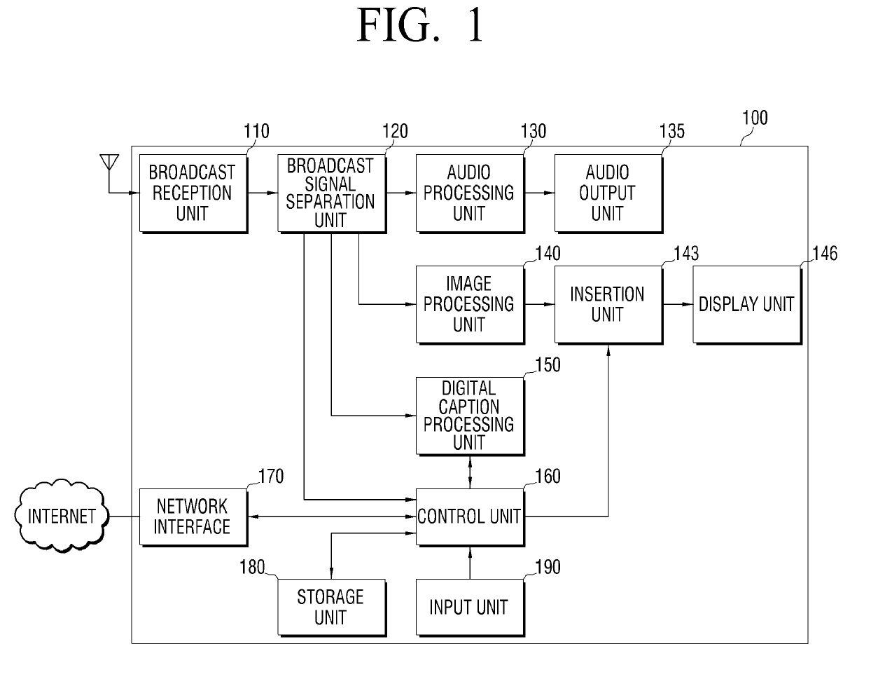

FIG. 1 is a schematic block diagram of a TV 100 according to an exemplary embodiment of the present invention. As illustrated in FIG. 1, the TV 100 may include a broadcast reception unit 110, a broadcast signal separation unit 120, an audio processing unit 130, an audio output unit 135, an image processing unit 140, an insertion unit 143, a display unit 146, a digital caption processing unit 150, a control unit 160, a network interface 170, a storage unit 180, and an input unit 190.

The broadcast reception unit 110 receives a broadcast from a broadcasting station or a satellite using a wired line or wirelessly, and demodulates the broadcast. The received broadcast signal may include electronic program guide (EPG) information and digital caption information.

The EPG information is information for a TV broadcast program guide to be displayed on the TV, including the title, genre, and broadcast time of the broadcast program.

The digital caption information indicates a digital caption received through the broadcast signal. A digital caption indicates text information containing a character's lines and sounds of a broadcast program as text on the screen. Such a digital caption enables a hearing-impaired person to view the TV. In addition, if a digital caption is displayed in a foreign language, the digital caption can be used for learning the language.

In general, caption broadcast schemes in a TV broadcast include open captions and closed captions. Open captions notify users of newsflashes or announcements according to the broadcaster's selection regardless of the user's selection by adding a caption signal to an active section of a TV signal. Closed captions display text together with broadcasts according to the user's selection if a caption signal is added to a non-active section of a TV signal, that is, a vertical blanking section, and received. In an exemplary embodiment in this specification, digital caption information indicates closed caption information.

The broadcast signal separation unit 120 separates an audio signal, a video signal, EPG information, and digital caption information from the demodulated broadcast signal. The broadcast signal separation unit 120 transmits the audio signal to the audio processing unit 130, transmits the video signal to the image processing unit 140, transmits the digital caption information to the digital caption processing unit 150, and transmits the EPG information to the control unit 160.

The audio processing unit 130 performs processing, such as audio decoding, on the audio signal. The audio processing unit 130 transmits the processed audio signal to the audio output unit 135.

The audio output unit 135 outputs the audio signal via a speaker.

The image processing unit 140 performs processing, such as video decoding and video scaling, on the input video signal, and outputs the processed video signal to the insertion unit 143.

The insertion unit 143 inserts text information received from the control unit 160, such as a digital caption, a marker indicating terminology to be explained, e.g., defined, and an explanation of the terminology, into the received video signal, and outputs an image including the text information to the display unit 146.

The display unit 146 displays the image output from the insertion unit 143. In particular, the display unit 146 displays an explanation of terminology to be explained, which is searched for by the control unit 160, on the screen.

The terminology to be explained is terminology which is included in a list of terminologies requiring an explanation, from among the terminology included in the digital caption information. That is, the terminology to be explained indicates terminology requiring explanation, such as a technical term or a coined word.

The terminology to be explained may include words, phrases, clauses, or sentences. For example, the terminology to be explained may be words such as “KOSPI” or “free throw”, phrases or clauses such as “Fourier signal processing method”, or sentences or proverbs such as “The early bird gets the worm”.

The display unit 146 displays a digital caption on the screen. If the terminology in the digital caption information is included in the list of terminologies to be explained, the display unit 146 displays the terminology in the digital caption information differently from the remaining terminology on the screen. Subsequently, if the user inputs a command to display explanation of the terminology using the input unit 190, the display unit 146 displays the explanation of the terminology on the screen.

In addition, the display unit 146 may display the explanation of the terminology even when the digital caption is not displayed on the screen. More specifically, if the terminology in the digital caption information is included in the list of terminologies to be explained, the display unit 146 displays the terminology in the digital caption information differently from the remaining terminology on the screen. For example, in the digital caption, the terminology to be explained may be displayed using bold type, a box, or an underline.

When the digital caption information is being displayed on the screen, if the user inputs a command to display an explanation of the terminology using the input unit 190, the display unit 146 displays the explanation of the terminology on the screen.

Alternatively, the display unit 146 may directly display an explanation of the terminology together with the terminology without displaying the terminology differently from the remaining terminology.

The display unit 146 may display an explanation of the terminology to be explained on screen, regardless of whether or not the digital caption is displayed on the screen.

The digital caption processing unit 150 decodes the received digital caption information into digital caption strings and outputs the decoded digital caption strings to the control unit 160.

The network interface 170 is a connection path to connect the TV 100 with the Internet. That is, the network interface 170 is communicably connected to the Internet.

The storage unit 180 stores the list of terminologies to be explained, so if terminology in the list is included in the digital caption information, the TV 100 displays explanation of the terminology on the screen.

The list of terminologies to be explained includes terminology which users may think are difficult. The list of terminologies to be explained may be stored when manufacturing the TV 100, or may be stored by the user. In addition, the list of terminologies to be explained may be edited by the user. That is, the user may add unknown terminology to the list and delete known terminology from the list.

In addition, the storage unit 180 may store explanations for a large amount of terminology. Explanations for the large amount of terminology may be stored in the form of a dictionary. Furthermore, the storage unit 180 may store a diverse range of dictionaries. For example, the storage unit 180 may store a dictionary of economic terms, a dictionary of sports terms, a dictionary of information technology terms, a dictionary of science terms, a Korean language dictionary, and an English language dictionary, explaining for the large amount of terminology.

However, the storage unit 180 may store only the list of terminologies to be explained without the explanations of the terminology. In this case, the explanations of the terminology may be searched for over the Internet.

The storage unit 180 may be implemented as a hard disk, a non-volatile memory, or the like.

The input unit 190 receives the user's manipulation and transmits information on the user's manipulation to the control unit 160. The input unit 190 may include a remote control or buttons provided on the TV 100.

The control unit 160 recognizes a user command based on the user's manipulation received from the input unit 190, and controls the overall operation of the TV 100 according to the user command.

If terminology in the digital caption information is included in the list of terminologies to be explained, the control unit 160 searches for an explanation of the terminology to be explained.

If the storage unit 180 stores a plurality of lists of terminology to be explained, which are categorized to correspond to particular titles or genres, the control unit 160 extracts information on the title or genre of a currently viewed broadcast program from the EPG information, and selects a list corresponding to the extracted information on the title or genre from among the plurality of lists of terminology to be explained. Subsequently, if terminology in the digital caption information is included in the selected list, the control unit 160 searches for an explanation of the terminology.

For example, it is assumed that the storage unit 180 stores a list of economic terminologies, a list of basketball terminologies, and a list of handball terminologies, as lists of terminologies to be explained. If the title of the currently viewed broadcast program is “economic news”, the genre of the program is “economy”, so the control unit 160 selects the list of economic terminologies as a list of terminologies to be explained. Alternatively, if the title of the currently viewed broadcast program is “International handball game round of 16”, the genre of the program is “sport” but the title of the program includes “handball”, so the control unit 160 selects the list of handball terminologies as a list of terminologies to be explained.

If an explanation belonging to a genre which is not related to the currently viewed broadcast program is displayed, the user may feel inconvenience due to receiving unnecessary information. Accordingly, in order to prevent this matter, the control unit 160 selects a list of terminologies to be explained corresponding to information on the title or genre of the currently viewed broadcast program.

The control unit 160 extracts information on the title or genre of the currently viewed broadcast program from the EPG information, and searches for an explanation of terminology to be explained corresponding to the extracted information.

More specifically, if there are a plurality of explanations for a single term to be explained, the control unit 160 searches for an explanation corresponding to the information on the title or genre of a currently viewed broadcast program.

For example, it is assumed that a basketball game is currently being viewed and “free throw” is included in a digital caption. The terminology “free throw” is used in both basketball and handball, so an explanation of “free throw” in basketball should be displayed. In this case, the control unit 160 extracts “basketball” from information on the title of the currently viewed broadcast program and searches for the meaning of “free throw” in basketball.

In addition, if there are a plurality of dictionaries of terminology (for example, a dictionary of economic terms, a dictionary of sports terms, a dictionary of information technology terms, a dictionary of science terms, a Korean language dictionary, an English language dictionary, and so on) in the storage unit 180 or on the Internet, the control unit 160 automatically selects a dictionary corresponding to information on the title or genre of the currently viewed broadcast program from among the plurality of dictionaries of terminology, and searches for an explanation of the terminology from the selected dictionary.

For example, if the currently viewed broadcast program is economic news, the control unit 160 extracts “economy” from information on the genre of the currently viewed broadcast program and searches for the meaning of the terminology to be explained from the dictionary of economic terms.

As described above, the control unit 160 selects a dictionary (namely, a set of explanations of terminology to be explained) corresponding to the currently viewed broadcast program so that the TV 100 can display explanations of terminology with greater precision.

In this exemplary embodiment of the present invention, the control unit 160 automatically selects a dictionary corresponding to information on the title or genre of the currently viewed broadcast program, but it is also possible for the user to personally select a dictionary.

For example, if terminology to be explained is present in digital caption information of a currently viewed broadcast program, the control unit 160 may display a list of dictionaries available together with the terminology to be explained on the screen. If the user selects one of the list of dictionaries available using the input unit 190, the control unit 160 searches for an explanation of the terminology to be explained from the dictionary.

If the storage unit 180 stores explanations for a large amount of terminology (that is, a dictionary of terminology), the control unit 160 searches for an explanation of terminology to be explained from among the stored explanations.

In addition, the control unit 160 may search for an explanation of terminology to be explained on the Internet. Websites on the Internet to search for the terminology to be explained may include general portal sites and a site provided by the manufacturer of the TV 100. Websites on the Internet to search for the terminology to be explained may also be selected by the user.

If digital caption information includes terminology which is included in the list of terminologies to be explained, the control unit 160 may control only the terminology to be displayed on the screen. If a manipulation to display an explanation of the terminology is input using the input unit 190, the control unit 160 displays the explanation of the terminology on the screen.

However, if the digital caption information is displayed on the screen, the control unit 160 controls the terminology to be explained in the digital caption information to be displayed differently from the remaining terminology on the screen. For example, the terminology to be explained in the digital caption may be displayed using bold type, a box, or an underline. If a command to display an explanation of the terminology to be explained is input using the input unit 190, the control unit 160 displays the explanation of the terminology to be explained on the screen.

The control unit 160 may select dictionaries to be searched (for example, a dictionary of economic terms, a dictionary of sports terms, a dictionary of information technology terms, a dictionary of science terms, a Korean language dictionary, an English language dictionary, and so on) as search objects or exclude any of the dictionaries to be searched from the search objects. For example, the dictionary of economic terms may be selected as a search object, and the dictionary of sports terms may be excluded from the search objects.

In addition, each dictionary may sort explanations of terminology into simple explanations and detailed explanations. Accordingly, when searching for terminology to be explained, the control unit 160 may select one of the simple explanation and the detailed explanation.

The control unit 160 may search for detailed information on terminology to be explained in a digital caption over the Internet and provide the user with the detailed information found.

When displaying an explanation of terminology to be explained on the screen, the control unit 160 may adjust the transparency of the explanation to be displayed on the screen according to the user's settings. Consequently, the user may select whether to concentrate on the broadcast screen or the explanation of the terminology.

As described above, if terminology to be explained is present in digital caption information, the TV 100 according to the exemplary embodiment of the present invention automatically displays an explanation of the terminology. Therefore, the user can conveniently know the meaning of technical terminology used in a broadcast program without separate manipulation.

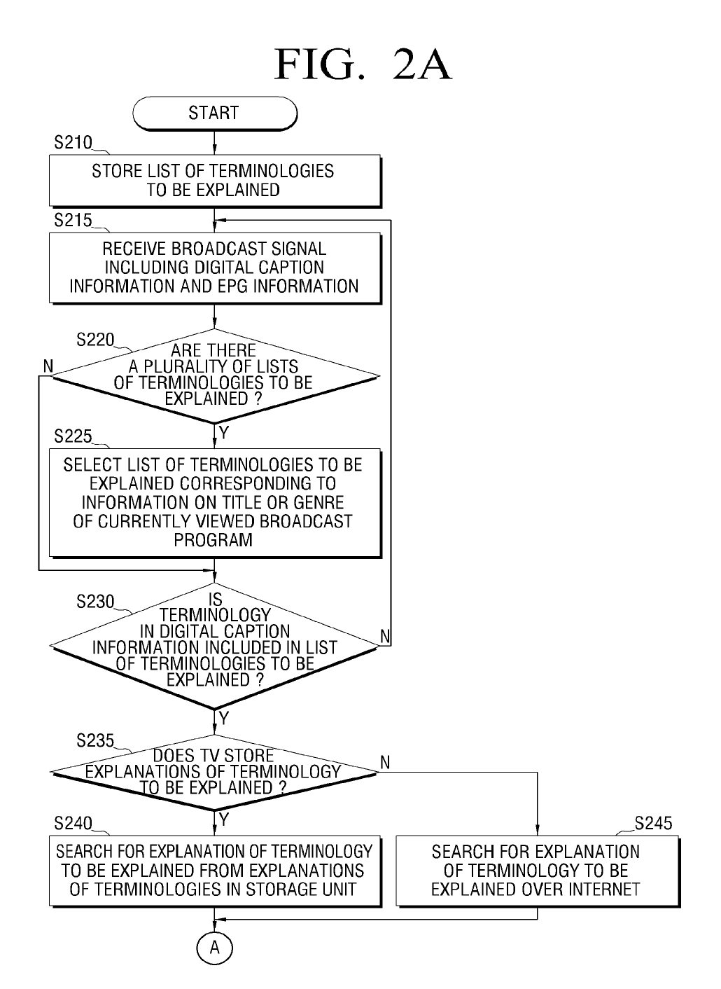

Hereinbelow, a method for displaying an explanation of terminology to be explained in a digital caption according to an exemplary embodiment of the present invention is described. FIGS. 2A and 2B are a flowchart of a method for processing a digital caption according to an exemplary embodiment of the present invention.

The TV 100 stores a list of terminologies to be explained in the storage unit 180 (S210), and receives a broadcast signal including digital caption information and EPG information (S215).

Subsequently, the TV 100 determines whether or not there are a plurality of lists of terminology to be explained (S220). If there are a plurality of lists of terminology to be explained (5220-Y), information on the title or genre of a currently viewed broadcast program is extracted, and a list of terminologies to be explained corresponding to the extracted information is selected from among the plurality of lists of terminology to be explained (S225).

For example, if the storage unit 180 stores a list of economic terminologies, a list of sports terminologies, and a list of information technology terminologies, and a currently viewed broadcast program is “economic news”, the TV 100 selects the list of economic terminologies corresponding to the term “economy” included in information on the title or genre of the economic news.

Subsequently, the TV 100 determines whether or not terminology in the digital caption information is included in the selected list of terminologies to be explained (S230). If none of the terminology in the digital caption information is included in the selected list of terminologies to be explained (S230-N), the TV 100 continues to receive the digital caption information (S215).

If terminology in the digital caption information is included in the selected list of terminologies to be explained (S230-Y), the TV 100 identifies whether or not the storage unit 180 in the TV 100 stores explanations (that is, a dictionary) of the terminology to be explained (S235).

If the storage unit 180 stores explanations (that is, a dictionary) of the terminology to be explained (S235-Y), the TV 100 searches for explanation of the terminology to be explained from among the explanations of terminology in the storage unit 180 (S240).

If the storage unit 180 does not store explanations (that is, a dictionary) of the terminology to be explained (S235-N), the TV 100 searches for an explanation of the terminology to be explained over the Internet using the network interface 170 (S245).

Later, the TV 100 determines whether or not there are a plurality of explanations of the terminology to be explained (S250). If there are a plurality of explanations of the terminology to be explained (S250-Y), the TV 100 selects an explanation corresponding to information on the title or genre of the currently viewed broadcast program (S255).

For example, the terminology “free throw” is used in both basketball and handball. If the title of a currently viewed broadcast program is “basketball game” and terminology to be explained in a digital caption is “free throw”, the TV 100 extracts “basketball” from the information on the title of the currently viewed broadcast program and searches for an explanation of “free throw” in basketball.

Subsequently, the TV 100 determines whether or not the digital caption is being displayed on the screen (S260). If the digital caption is being displayed on the screen (5260-Y), the TV 100 displays the terminology to be explained in the digital caption differently from the remaining terminology on the screen (S265). (For example, in the digital caption, the terminology to be explained may be displayed using bold type, a box, or an underline.)

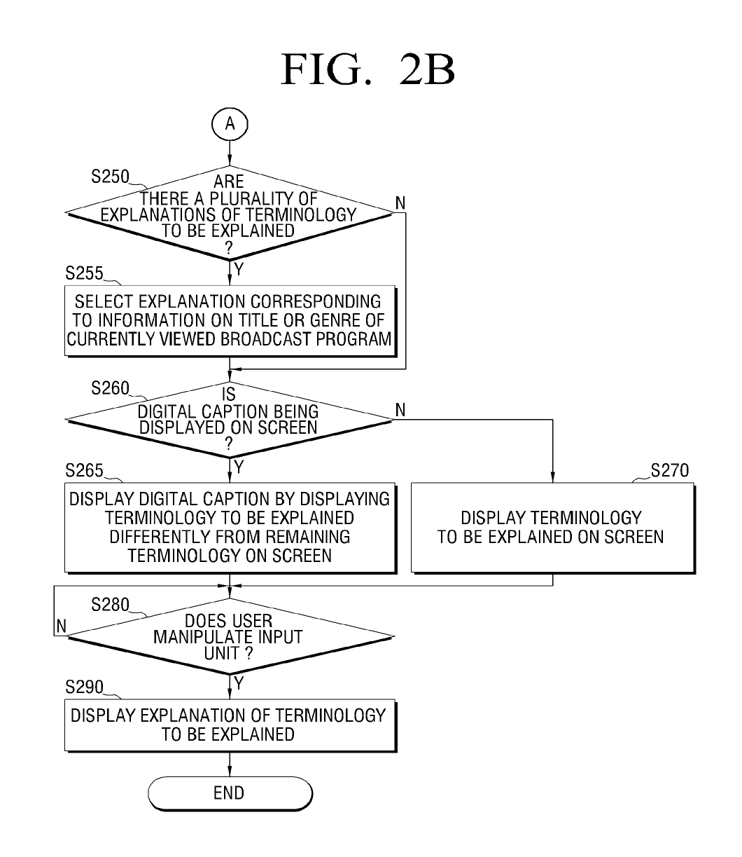

Displaying the terminology to be explained differently from the remaining terminology on the screen is described with reference to FIGS. 3A and 3B. FIG. 3A illustrates terminology to be explained in a digital caption using bold type according to an embodiment of the present invention.

As illustrated in FIG. 3A, the TV 100 is showing a digital caption 310. In FIG. 3A, “free throw” is the terminology to be explained 320 and thus is displayed using bold type.

FIG. 3B illustrates terminology to be explained in a digital caption in a boxed form according to another embodiment of the present invention.

In FIG. 3B, the TV 100 is showing a digital caption 310. In FIG. 3B, “free throw” is the terminology to be explained 330 and thus is displayed using a box.

In this manner, the TV 100 can display a digital caption and at the same time shows what the terminology to be explained is on the digital caption.

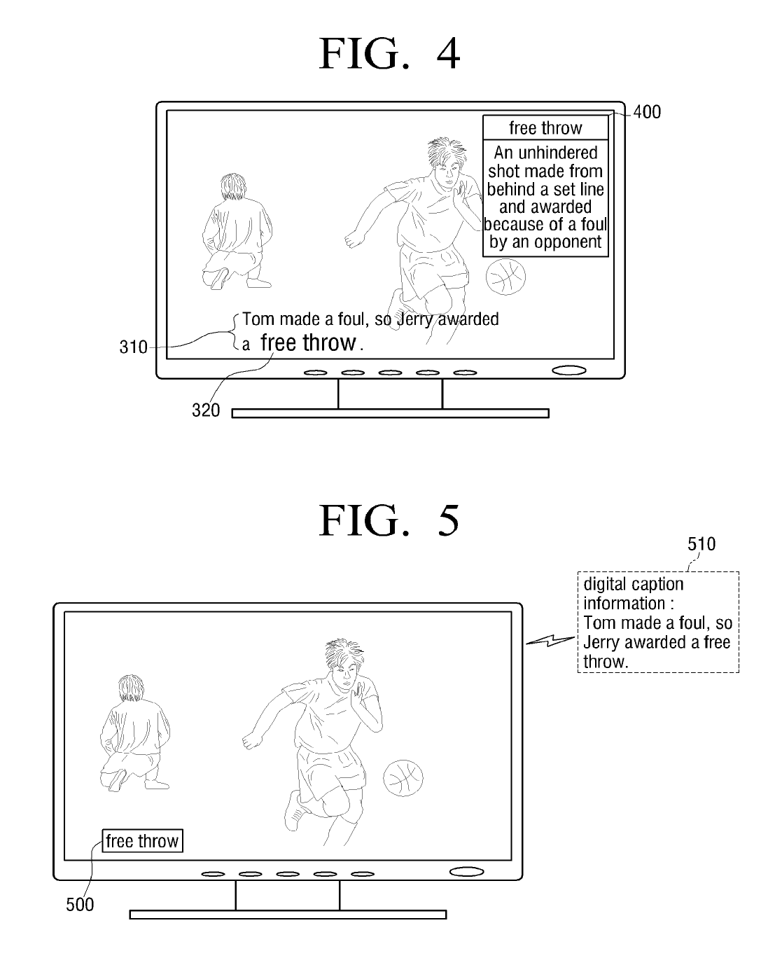

If the digital caption is not being displayed on the screen (S260-N), the TV 100 displays the terminology to be explained on the screen (S270). This is described here in detail with reference to FIG. 5.

FIG. 5 illustrates a screen displaying terminology to be explained when a digital caption is not displayed according to an embodiment of the present invention.

In FIG. 5, digital caption information 510 is received together with a broadcast signal but is not displayed on the screen. However, since “free throw” 500, the terminology to be explained, is included in the received digital caption information 510, only “free throw” 500 is displayed on the screen.

Subsequently, the TV 100 identifies whether or not the user manipulates the input unit 190 (S280). The input unit 190 includes a button to display an explanation of the terminology, so if the user presses the button, a command to display an explanation of the terminology is input.

Accordingly, if the user presses the button on the input unit 190 (5280-Y), the TV 100 displays an explanation of the terminology to be explained on the screen (S290).

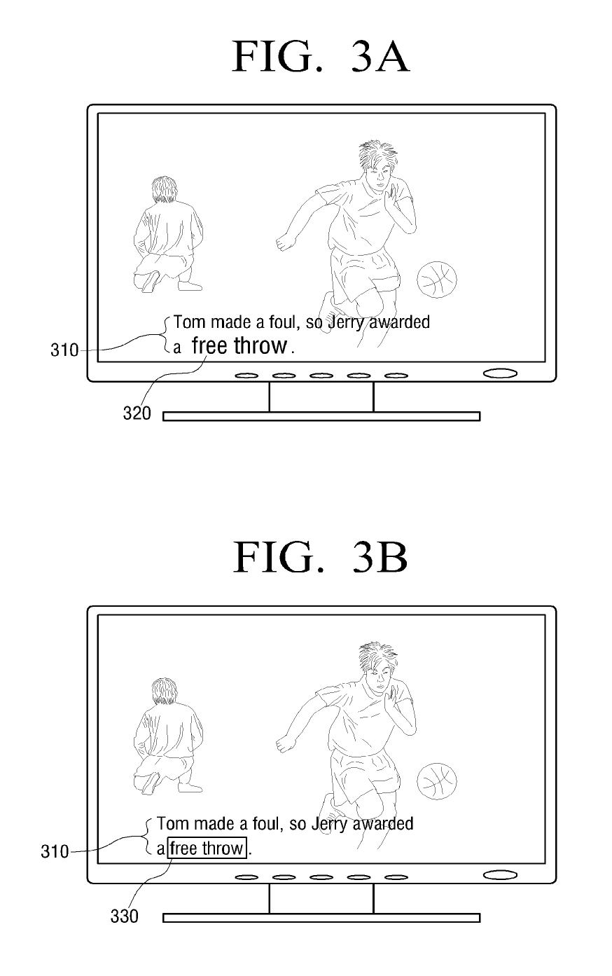

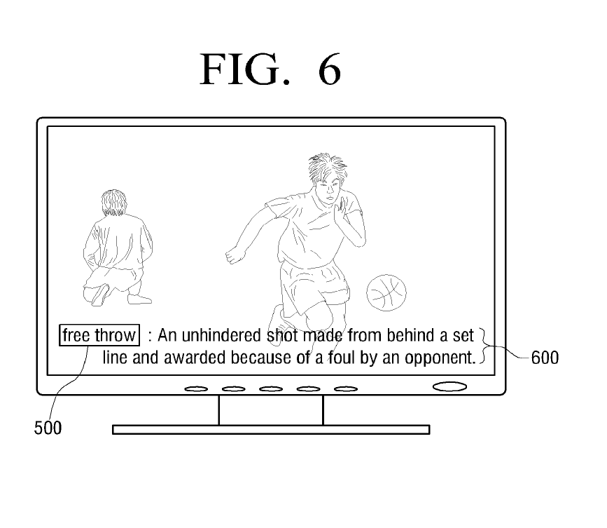

Methods for the TV 100 displaying an explanation of terminology to be explained are described in detail with reference to FIGS. 4 and 6.

FIG. 4 illustrates a screen displaying an explanation of terminology to be explained according to an embodiment of the present invention. In FIG. 4, a digital caption 310 is displayed and the terminology to be explained 320 is displayed.

As illustrated in FIG. 4, a separate window 400 for an explanation of the terminology to be explained 320 may be provided.

FIG. 6 illustrates a screen displaying terminology to be explained when a digital caption is not displayed according to another embodiment of the present invention.

When a digital caption is not displayed on the screen, the TV 100 displays only terminology 500 to be explained first as illustrated in FIG. 5. If the user presses the button to display an explanation of terminology 500 on the input unit 190, the explanation 600 of the terminology 500 to be explained is displayed next to the terminology 500 to be explained as illustrated in FIG. 6.

In the above exemplary embodiments of the present invention, a dictionary corresponding to information on the title or genre of a currently viewed broadcast program is selected automatically, but it is also possible for the user to personally select a dictionary.

For example, if terminology to be explained is present in digital caption information of a currently viewed broadcast program, the TV 100 may display a list of dictionaries available together with the terminology to be explained on the screen. Subsequently, the TV 100 searches for an explanation of the terminology to be explained from a dictionary selected by the user.

In the above exemplary embodiments of the present invention, terminology to be explained is displayed and then if the user presses a button to display an explanation of the terminology to be explained, the explanation of the terminology to be explained is displayed. However, it is also possible to directly display an explanation of the terminology to be explained together with the terminology.

That is, in FIG. 2B, operations S265, S270, and S280 are omitted, and operation S290 may be directly performed. In this case, if the TV 100 is displaying a digital caption (5260-Y), terminology to be explained and its explanation are displayed as illustrated in FIG. 4. Alternatively, if the TV 100 is not displaying a digital caption (S260-N), terminology to be explained and its explanation are displayed as illustrated in FIG. 6.

In the above exemplary embodiments of the present invention, the broadcast receiver is a TV, but the technical idea of the present invention can be applied to any kind of broadcast receiver capable of receiving a digital caption, such as a set-top box or a digital multimedia broadcasting (DMB) receiver.

As can be appreciated from the above description of the present invention, a broadcast receiver which searches for an explanation of terminology and displays explanation of the terminology on a screen if the terminology in the digital caption information is included in a list of terminologies to be explained, and a method for processing a digital caption using the same are provided. Accordingly, the user can easily understand the meaning of the terminology on a broadcast program.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a reception unit which receives a content containing digital caption information;
a storage unit which stores a list of terminologies;
a control unit which determines terminology in the digital caption based on comparison between the digital caption information and the stored list of terminologies, and which searches for an explanation of the terminology if the terminology is determined; and
a display unit which displays the explanation of the terminology to be explained, on a screen,
wherein the control unit selects the stored list of terminologies from a plurality of lists based on the content provided with the digital caption and wherein the displayed explanation of the determined terminology is provided from the selected stored list of terminologies.

2. The display apparatus according to claim 1, wherein the reception unit receives electronic program guide (EPG) information together with the digital caption information, and
the control unit extracts information on a title of a currently viewed content or information on a genre of the currently viewed content from the EPG information, and searches for the explanation of the terminology corresponding to the extracted information on the title or the genre of the currently viewed content.

3. The display apparatus according to claim 1, wherein the reception unit receives electronic program guide (EPG) information together with the digital caption information,
the storage unit stores a plurality of lists of terminologies, which are categorized, and
the control unit extracts information on a title or information on a genre of a currently viewed content from the EPG information, selects a list of terminologies corresponding to the extracted information on the title or the genre of the currently viewed content, from among the plurality of lists of terminologies, and searches for the explanation of the terminology if the terminology in the digital caption information is determined.

4. The display apparatus according to claim 1, wherein the storage unit stores explanations for terminologies of the list of terminologies, and
the control unit searches for the explanation of the terminology from the explanations stored in the storage unit if the terminology in the digital caption information is determined.

5. The display apparatus according to claim 1, further comprising:
a network interface which is communicably connected to the Internet, wherein the control unit searches for the explanation of the terminology, over the Internet through the network interface if the terminology in the digital caption information is determined.

6. The display apparatus according to claim 1, wherein the display unit displays the explanation for the terminology on the screen even when the digital caption information is not displayed on the screen.

7. The display apparatus according to claim 1, further comprising:
an input unit which receives a user input, wherein the display unit displays the terminology on the screen if the terminology in the digital caption information is determined, and displays the explanation of the terminology on the screen if a predetermined user input is input through the input unit when the terminology is displayed on the screen.

8. The display apparatus according to claim 1, further comprising:
an input unit which receives a user input, wherein the display unit displays the digital caption information on the screen by displaying the terminology in the digital caption information differently from remaining terminology on the screen if the terminology in the digital caption information is determined, and displays the explanation of the terminology on the screen if a predetermined user input is input through the input unit when the terminology is displayed on the screen.

9. The display apparatus according to claim 1, further comprising:
an input unit which receives a user input, wherein the display unit displays a list of dictionaries on the screen if the terminology in the digital caption information is determined, and
the control unit searches for the explanation of the terminology from a dictionary selected through the input unit, from among the list of dictionaries.

10. The display apparatus according to claim 1, wherein the terminology comprises at least one of words, phrases, clauses, and sentences.

11. A method for processing a digital caption for a display apparatus, the method comprising:
storing a list of terminologies;
receiving a content containing digital caption information;
selecting a stored list of terminologies from a plurality of stored lists based on the content provided with the digital caption information;
determining terminology in the received digital caption information based on comparison between the digital caption information and the stored list of terminologies, searching for an explanation of the determined terminology if the terminology is determined; and
displaying the explanation of the terminology, on a screen,
wherein the displayed explanation of the determined terminology is provided from the selected stored list of terminologies.

12. The method according to claim 11, further comprising:
receiving electronic program guide (EPG) information; and
extracting information on a title of a currently viewed content or information on a genre of the currently viewed content from the EPG information,
wherein in the searching operation, the explanation of the terminology corresponding to the extracted information on the title or the genre of the currently viewed content is searched for.

13. The method according to claim 11, further comprising:
receiving electronic program guide (EPG) information;
extracting information on a title a currently viewed content or information on a genre of the currently viewed content from the EPG information; and
selecting a list of terminologies corresponding to the extracted information on the title or the genre of the currently viewed content, from among a plurality of lists of terminologies,
wherein in the storing operation, the plurality of lists of terminologies are categorized in a categorization and stored according to the categorization, and in the searching operation, if the terminology in the digital caption information is included in the selected list of terminologies, the explanation of the terminology is searched for.

14. The method according to claim 11, further comprising:
storing explanations for terminologies of the list of terminologies,
wherein in the searching operation, if the terminology, in the digital caption information is determined, the explanation of the terminology is searched for from the stored explanations.

15. The method according to claim 11, further comprising:
being communicably connected to the Internet through a network interface, wherein in the searching operation, if the terminology, in the digital caption information is determined, the explanation of the terminology is searched for through the Internet.

16. The method according to claim 11, wherein in the displaying operation, the explanation for the terminology is displayed on the screen when the digital caption information is not displayed on the screen.

17. The method according to claim 11, wherein the displaying operation comprises:
displaying the terminology on the screen if the terminology in the digital caption information is determined; and displaying the explanation of the terminology on the screen if a predetermined input is input through an input unit when the terminology is displayed on the screen.

18. The method according to claim 11, wherein the displaying operation comprises:
displaying the digital caption information on the screen by displaying the terminology, in the digital caption information differently from remaining terminology on the screen if the terminology in the digital caption information is determined; and
displaying the explanation of the terminology on the screen if a predetermined input is input through an input unit when the terminology is displayed on the screen.

19. The method according to claim 11, further comprising:
displaying a list of dictionaries on the screen if the terminology in the digital caption information is determined,
wherein in the searching operation, the explanation of the terminology is searched for from a dictionary selected through the input unit, from among the list of dictionaries.

20. The method according to claim 11, wherein the terminology comprises at least one of words, phrases, clauses, and sentences.

21. A method for processing a digital caption for a display apparatus, the method comprising:
storing a list of terminologies;
receiving a content containing digital caption information;
determining terminology in the received digital caption information based on comparison between the digital caption information and the stored list of terminologies,
searching for an explanation of the determined terminology if the terminology is determined;
displaying the explanation of the terminology, on a screen; and
selecting a list of terminologies from a plurality of lists based on EPG information received together with the digital caption information,
wherein the plurality of lists are prestored in the display apparatus and are modifiable by a user that views the content provided by the display apparatus.

22. The method according to claim 21, wherein the plurality of lists are lists of terms without definitions and wherein the definitions for a term on one of the plurality of lists is obtained from a user-designated site and wherein the digital caption information is open captions.

23. The display apparatus according to claim 1, wherein the control unit selects the list of terminologies from the plurality of lists based on EPG information received together with the digital caption information and wherein the plurality of lists are prestored in a display apparatus and are modifiable by a user that views the content provided by the display apparatus.

24. The display apparatus according to claim 1, wherein a plurality of lists are lists of terms without definitions and wherein the definitions for a term on one of the plurality of lists is obtained from a user-designated site.

25. The method according to claim 11, wherein the selecting the stored list of terminologies from the plurality of lists is based on genre of the content.

26. A method for processing a digital caption for a display apparatus, the method comprising:
storing a list of terminologies;
receiving a content containing digital caption information;
determining terminology in the received digital caption information based on comparison between the digital caption information and the stored list of terminologies,
searching for an explanation of the determined terminology if the terminology is determined; and
outputting the explanation of the terminology,
wherein the output explanation of the determined terminology varies based on the content provided with the digital caption, and
wherein the stored list of terminologies are modifiable by a user.

27. The method according to claim 11, further comprising selecting said one stored list of terminologies from the plurality of lists based on EPG information.

28. The method according to claim 27, wherein the plurality of lists are modifiable by a user that views the content provided by the display apparatus.

29. The method according to claim 11, wherein the plurality of lists are lists of terms without definitions and wherein the definitions for a term on one of the plurality of lists is obtained from a user-designated site.

30. A terminology management server, comprising;
a communication unit which communicates with a display apparatus;
a storage unit which stores a list of terminologies; and
a control unit which if digital caption information is received from the display apparatus through the communication unit, determines whether terminology exists among terminologies included in the digital caption information based on the list of terminologies stored in the storage unit, and if the terminology exists, controls the communication unit to transmit the terminology to the display apparatus.

31. A content providing system, comprising;
a display apparatus which displays contents and digital caption information related to the contents, and displays a terminology in the digital caption information on the screen; and
a terminology management server which if the digital caption information is received from the display apparatus, transmits terminology from among terminologies in the digital caption information to the display apparatus based on a pre-stored list of terminologies,
wherein the display apparatus stores explanation for categorized terminologies, and if terminology is received from the terminology management server, determines a category based on a content type, and obtains explanation for the received terminologies within the determined category.
